(19) United States
(12) Patent Application Publication
(10) Pub. No.: US 2023/0198443 A1
(43) Pub. Date: Jun. 22, 2023

(54) Six-phase Switched Reluctance Motor, and Sensorless Rotor Position Estimation Method and System

(71) Applicant: Hangzhou Silicon Bay Technologies co. , Ltd, Hangzhou (CN)

(72) Inventors: Li Fang, Hangzhou (CN); Hanwen Zhao, Hangzhou (CN)

(73) Assignee: Hangzhou Silicon Bay Technologies co. , Ltd, Hangzhou (CN)

(21) Appl. No.: 18/108,689

(22) Filed: Feb. 13, 2023

(30) Foreign Application Priority Data
Aug. 8, 2022 (CN) 202210943490.3

(51) Int. Cl. H02P 25/089; H02K 19/10

(52) U.S. Cl. CPC H02P 25/089; H02K 19/103; H02K 2213/03

(57) ABSTRACT

The present invention discloses a six-phase switched reluctance motor, and a sensorless rotor position estimation method and system. The six-phase switched reluctance motor includes a stator assembly and a rotor assembly, the stator assembly includes a stator core, the stator core includes stator teeth and a stator yoke, and the stator teeth are provided with windings; and the number Ns of the stator teeth is a multiple of 6, every six adjacent windings form a six-phase winding, a plurality of sets of six-phase windings are provided, one ends of each set of six-phase windings are connected to each other to form a common terminal, and the other ends of each set of six-phase windings are connected to a controller interface.

### TECHNICAL FIELD

The present invention relates to the technical field of reluctance motors, in particular to a six-phase switched reluctance motor, and a sensorless rotor position estimation method and system.

### BACKGROUND ART

A switched reluctance motor is a new type of speed control motor, which is mainly used in a speed control system to realize the conversion of electromechanical energy. The common switched reluctance motor is mainly a motor of a double salient pole structure, and the main raw material of salient poles of a stator and a rotor of the motor is a silicon steel sheet or copper, so no permanent magnet is needed. Therefore, the switched reluctance motor has the advantages of simple structure and low cost, may completely avoid the negative impact of demagnetization of permanent magnets on motor performance, and has broad application prospects in all fields. Generally, the rotor of the switched reluctance motor has neither windings nor permanent magnets, and the stator has windings. At the same time, the switched reluctance motor operates mainly by determining the on/off of current in phase windings based on the change of a rotor position. Therefore, the availability of a highly reliable and accurate rotor position determines the performance of the switched reluctance motor.

In the prior art, the rotor position is obtained mainly by: a position sensor solution and a sensorless solution. The sensor solution is to detect the rotor position with a position sensor. Common position sensors used in conjunction with switched reluctance motors include Hall sensors, photoelectric encoders, resolvers, etc. However, the assembly difficulty and cost of a motor system are increased due to the use of the position sensor. Moreover, the position sensor has low accuracy and reliability in some occasions with harsh working conditions, which affects the normal operation of the motor system. The sensorless solution is mainly applied to a sensorless method for switched reluctance motors, including: a current flux linkage method, an inductance observer method and an intelligent control method. However, these methods have a large data size, non-transferability and low reliability. For example, the current flux linkage method is mainly based on a saliency effect of a switched reluctance motor, and since different rotor positions have inconsistent current-flux linkage curves, relatively accurate results may be obtained only by acquiring a large number of current-flux linkage characteristic curves for analysis. As a result, the method has poor portability, and the statistical workload is increased.

### SUMMARY OF THE INVENTION

The present invention aims to provide a six-phase switched reluctance motor, and a sensorless rotor position estimation method and system respectively in order to overcome the defects in the prior art. By providing a common terminal, the number of leads of the motor is reduced, the complexity of winding and the leads is reduced, and the cost is reduced. By means of the sensorless rotor position estimation method, there is no need to measure a large amount of flux linkage-current data in advance, the calculation quantity is reduced, the stability is improved, and the accuracy of position estimation is improved.

In order to achieve the above-mentioned objective, in a first aspect, the present invention provides a six-phase switched reluctance motor. The six-phase switched reluctance motor includes a stator assembly and a rotor assembly, the stator assembly includes a stator core, the stator core includes stator teeth and a stator yoke, and the stator teeth are provided with windings; and

the number Ns of the stator teeth is a multiple of 6, every six adjacent windings form a six-phase winding, a plurality of sets of six-phase windings are provided, one ends of each set of six-phase windings are connected to each other to form a common terminal, and the other ends of each set of six-phase windings are connected to a controller interface.

Preferably, a relationship between the number Ns of the stator teeth and the number Nr of rotor teeth meets:

$$\frac{{N}_{s}}{{N}_{r}} = \frac{6}{5} or \frac{6}{7} .$$

Preferably, a winding manner of the six-phase windings is NNNNNN or SSSSSS or NSNSNS or NNSSNN or NNNSSS, N representing winding in a clockwise direction, S representing winding in a counterclockwise direction.

Preferably, a winding manner of the six-phase windings is NNNNNN or SSSSSS in the case that the number Ns of the stator teeth is 12.

Preferably, the stator yoke at least includes hsy0 and hsy1 areas of unequal widths, and the hsy0 areas and the hsy1 areas are arranged alternately in a circumference direction of the stator yoke.

Preferably, the six-phase switched reluctance motor is provided as an outer rotor motor or an inner rotor motor or a linear motor or a disc motor or a cascade motor or a special-shaped motor.

Preferably, auxiliary permanent magnets or/and electrically excited windings are disposed on the stator assembly or/and the rotor assembly.

Preferably, the stator core is of a salient pole structure; and the rotor assembly includes a rotor core, and the rotor core is also of a salient pole structure.

Preferably, when the rotor assembly is driven by an external force to make directional movement, rotor teeth cut a magnetic field on the stator windings to form an induced current output, such that the six-phase switched reluctance motor has a function of efficient electricity generation.

In addition, the present invention further provides a sensorless rotor position estimation method implemented by the above six-phase switched reluctance motor. The method includes:

acquiring a current value and a voltage value in six-phase windings, a control waveform in the six-phase windings being square wave, sine wave or part of sine wave;

calculating a flux linkage value based on the acquired current value and voltage value; and

estimating an actual position and operating speed of a rotor assembly based on the current value, the voltage value and the flux linkage value.

In addition, the present invention further provides a sensorless rotor position estimation system for a six-phase switched reluctance motor. The system includes:

a data acquisition module, configured to acquire a current value and a voltage value in six-phase windings, a control waveform in the six-phase windings being square wave, sine wave or part of sine wave;

a data processing module, configured to calculate a flux linkage value based on the acquired current value and voltage value; and

an inductance calculation module, configured to estimate an actual position and operating speed of a rotor assembly based on the current value, the voltage value and the flux linkage value.

Compared with the prior art, the present invention has the following technical effects:

According to the six-phase switched reluctance motor in the above technical solution, the number of leads of the motor is reduced, the complexity of winding and the leads is reduced, and the cost is reduced. In addition, by means of the sensorless rotor position estimation method according to the present invention, the voltage and current of the six-phase windings is acquired through the data acquisition module, the flux linkage of the six-phase windings is calculated through the data processing module, and the actual position and actual operating speed of the rotor assembly are estimated through the inductance calculation module. Therefore, the calculation quantity is low, the stability is high, position estimation is accurate, the torque fluctuation and noise of the motor are substantially lowered due to the increase of the number of phases, and the application scenarios are broad.

### BRIEF DESCRIPTION OF THE DRAWINGS

FIG. 1 shows schematic diagrams of a structure of a six-phase switched reluctance motor with twelve stator teeth, and a connection method of windings and a controller according to an embodiment of the present invention.

FIG. 2 shows schematic diagrams of a structure of a conventional six-phase switched reluctance motor with twelve stator teeth, and a connection method of windings and a controller.

FIG. 3 shows schematic diagrams of coil winding combination manners according to an embodiment of the present invention.

FIG. 4 shows diagrams of various optional motor structures according to an embodiment of the present invention.

FIG. 5 shows a structural diagram of a six-phase switched reluctance motor with a stator yoke being in a non-uniform manner in a circumference direction according to an embodiment of the present invention.

FIG. 6 shows a flow diagram of sensorless rotor position estimation according to an embodiment of the present invention.

FIG. 7 shows a dynamometric data curve and a specific data table obtained from tests according to an embodiment of the present invention.

Reference numerals: 1. stator assembly; 11. stator yoke; 12. stator tooth; 2. rotor assembly; and 3. winding.

### DETAILED DESCRIPTION OF THE INVENTION

In order to make the objectives, technical solutions and advantages of the present invention clearer, the technical solutions of the present invention will be clearly and completely described below in conjunction with specific embodiments and corresponding accompanying drawings. Apparently, the described embodiments are only a part of the embodiments of the present invention, rather than all the embodiments. Based on the embodiments of the present invention, all other embodiments obtained by persons of ordinary skill in the art without creative efforts shall fall within the scope of the present invention.

It is to be noted that the expressions “first”, “second” and the like used in the embodiments of the present invention are merely for the purpose of description and should not be construed as indicating or implying the number of technical features defined, and thus the features defined as “first”, “second” in the embodiments of the present description may indicate that at least one of the technical features defined is included.

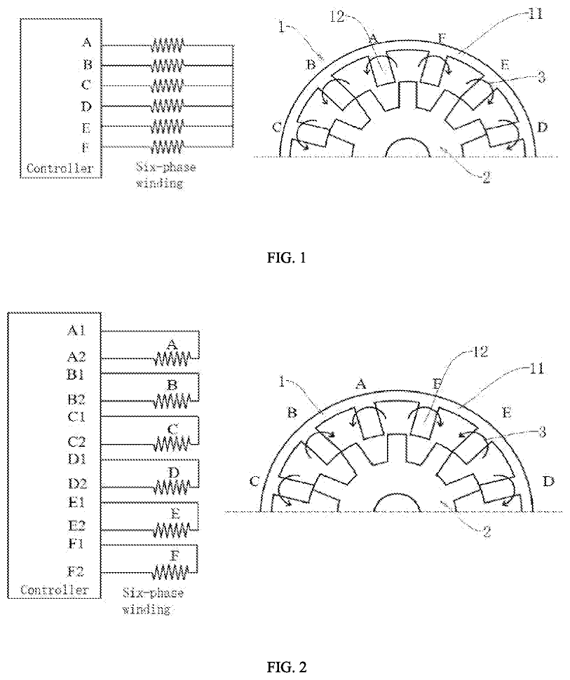

Referring to FIG. 1, a six-phase switched reluctance motor according to the present invention includes a stator assembly 1 and a rotor assembly 2. The stator assembly 1 includes a stator core. The stator core includes stator teeth 12 and a stator yoke 11. The rotor assembly 2 includes a rotor core. The stator core and the rotor core are each of a salient pole structure. The stator teeth 12 are provided with windings 3. The number Ns of the stator teeth 12 is a multiple of 6. Every six adjacent windings 3 form a six-phase winding 3. A plurality of sets of six-phase windings 3 are provided. One ends of each set of six-phase windings 3 are connected to each other to form a common terminal, and the other ends of each set of six-phase windings are connected to a controller interface.

According to this embodiment, a motor corresponding to every six windings 3 may be set as the minimum unit motor, and when the number Ns of the stator teeth 12 is greater than 6, every six windings 3 form 1 phase, for a total of six phases.

According to a preferred embodiment, a relationship between the number Ns of the stator teeth 12 and the number Nr of rotor teeth meets:

$$\frac{{N}_{s}}{{N}_{r}} = \frac{6}{5} or \frac{6}{7} .$$

According to one embodiment of the present invention, taking a six-phase switched reluctance motor with twelve stator teeth 12 as an example, each coil is wound on the stator teeth 12, six adjacent windings 3 along the circumference belong to six phases: A, B, C, D, E, and F, respectively, and every two radially opposite windings 3 are of the same phase. One ends of the six-phase windings 3 are connected to each other to form a common terminal, and the other ends of the six-phase windings are connected to a controller interface.

Referring to FIG. 2, taking a conventional six-phase switched reluctance motor with twelve stator teeth 12 as an example, each coil is wound on the stator teeth 12, winding directions of adjacent coils are alternate, six adjacent windings 3 along the circumference belong to six phases: A, B, C, D, E, and F, respectively, every two radially opposite windings 3 are of the same phase, and leads at two ends of each phase are connected to a controller. Compared with the conventional six-phase switched reluctance motor with the twelve stator teeth, the six-phase switched reluctance motor with the twelve stator teeth has the advantages that by introduction of the common terminal, the number of leads is reduced from 12 to 6, the complexity of the leads is reduced, and the cost of the controller is reduced.

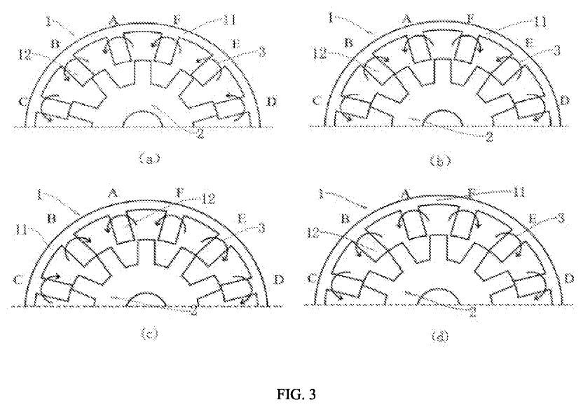

Referring to FIG. 3, the six-phase windings 3 in the unit motor have various winding manners, that is, winding directions of adjacent coils have various combinations. Specifically, by using “N” to represent a winding 3 in the clockwise direction and using “S” to represent a winding 3 in the counterclockwise direction, the windings 3 have the combination manners of “NNNNNN”, “SSSSSS”, “NSNSNS”, “NNSSNN”, “NNNSSS”, etc. FIG. 3-a shows a schematic diagram of the winding manner of “NNNNNN” or “SSSSSS”. FIG. 3-b shows a schematic diagram of the winding manner of “NSNSNS”. FIG. 3-c shows a schematic diagram of the winding manner of “NNSSNN”. FIG. 3-d shows a schematic diagram of the winding manner of “NNNSSS”.

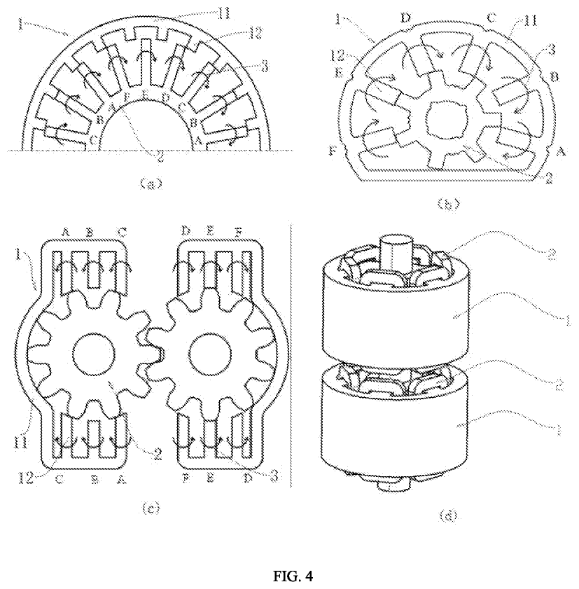

Referring to FIG. 4, the six-phase switched reluctance motor may be provided as an outer rotor motor or an inner rotor motor or a linear motor or a disc motor or a cascade motor or a special-shaped motor. FIG. 4-a shows an outer rotor motor with eighteen stator teeth 12. FIG. 4-b shows a special-shaped motor with six stator teeth 12. FIG. 4-c shows a multi-axis motor with twelve stator teeth 12. FIG. 4-d shows a cascade motor including an upper stator, a lower stator, an upper rotor and a lower rotor, with a total of twelve stator teeth 12 for the entire motor system.

Referring to FIG. 5, the stator yoke 11 at least includes hsy0 areas and hsy1 areas, and the hsy0 areas and the hsy1 areas are arranged alternately in a circumference direction of the stator yoke. Specifically, the width of the stator yoke 11 may be decreased at an interval of one or more teeth, that is, hsy1<hsy0. Preferably, the proportional relationship is hsy1=1/2 hsy0. According to other embodiments, the stator yoke 11 may also include two or more areas of unequal widths, such as hsy0 areas, hsy1 areas, and hsy2 areas, with a width relationship being hsy2<hsy1<hsy0. In this way, the weight of the stator core may be reduced without affecting the performance of the motor. In addition, the stator core in a stepped shape is more conducive to fixing during assembly.

According to other embodiments, an auxiliary permanent magnet or electrically excited winding 3 may also be provided on the stator assembly 1, and an auxiliary permanent magnet or electrically excited winding 3 may also be provided on the rotor assembly 2.

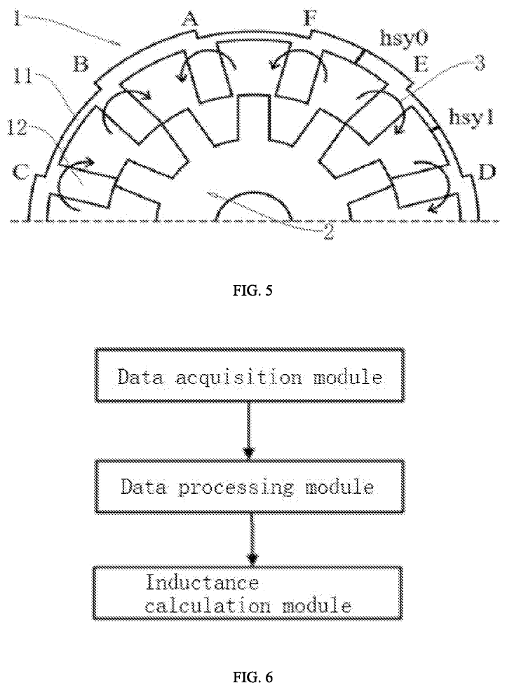

Based on the above six-phase switched reluctance motor, the present invention further provides a sensorless rotor position estimation method and system for the six-phase switched reluctance motor. As shown in FIG. 6, the system specifically includes:

(1) a data acquisition module, configured to acquire a current value and a voltage value in six-phase windings 3, a control waveform in the six-phase windings 3 being square wave, sine wave or part of sine wave;

(2) a data processing module, configured to calculate a flux linkage value based on the acquired current value and voltage value; and

(3) an inductance calculation module, configured to estimate an actual position and operating speed of a rotor assembly 2 based on the current value, the voltage value and the flux linkage value.

Specifically, the data acquisition module acquires the voltage value and the current value of the connecting position of the six-phase windings 3 and a controller in real time by means of current sampling and voltage sampling; the data acquisition module is connected to the data processing module, and the data processing module converts six-phase signals into signals in a two-phase α-β stationary coordinate system through coordinate transformation; and the data processing module is connected to the inductance calculation module, and the inductance calculation module calculates inductance in the two-phase α-β stationary coordinate system. Since the inductance in the two-phase α-β stationary coordinate system is related to the position of the motor, the real-time position of a rotor may be estimated, and the real-time speed of the motor may be estimated by taking the derivative of the rotor position.

The system and the modules described in the above embodiments may be specifically implemented by computer chips or entities, or by products with some functions. An exemplary implementation device is a computer. Specifically, the computer may be, for example, a personal computer, a laptop computer, a cellular phone, a camera phone, a smart phone, a personal digital assistant, a media player, a navigation device, an email device, a gaming console, a tablet computer, a wearable device, or a combination of any of these devices. For the convenience of description, the above system is divided into various modules based on functions. Of course, during the implementation of the present invention, the functions of the modules may be implemented in one or more software and/or hardware.

A voltage equation of the six-phase switched reluctance motor may be expressed as follows:

$${U}_{k} = {R}_{k} {i}_{k} - {e}_{k} = {R}_{k} {i}_{k} - \frac{d {Ψ}_{k}}{dt} \qquad ( 1 )$$

where Uₖ, Rₖ, iₖ, eₖ and ψₖ are an applied voltage, resistance, current, induced electromotive force, and flux linkage of a winding of a kth phase respectively.

The six-phase signals in natural coordinates are converted to the two-phase α-β stationary coordinate system through a coordinate transformation method as:

[f_{α}f_{β}]^{T}=T_{αβ}[fₐ f_{b} f_{c} f_{d} fₑ f_{f}]^{T} (2)

where f denotes a signal, including a voltage signal, a current signal, a flux linkage signal, an inductance signal, etc. A transformation matrix T_{αβ} is:

$${T}_{α β} = [ \begin{matrix}1 & - \frac{1}{2} & - \frac{1}{2} & \frac{\sqrt{3}}{2} & - \frac{\sqrt{3}}{2} & 0 \\ 0 & \frac{\sqrt{3}}{2} & - \frac{\sqrt{3}}{2} & \frac{1}{2} & \frac{1}{2} & - 1\end{matrix} ] \qquad ( 3 )$$

Therefore, through the current sampling and voltage sampling on the six-phase winding and the six phase-two phase coordinate transform, U_{α}, U_{β}, i_{α} and i_{β} in the two-phase α-β stationary coordinate system may be calculated.

In the two-phase α-β stationary coordinate system:

$$[ \begin{matrix}{U}_{α} \\ {U}_{β}\end{matrix} ] = R [ \begin{matrix}{i}_{α} \\ {i}_{β}\end{matrix} ] - [ \begin{matrix}{e}_{α} \\ {e}_{β}\end{matrix} ] = R [ \begin{matrix}{i}_{α} \\ {i}_{β}\end{matrix} ] - [ \begin{matrix}\frac{d {Ψ}_{α}}{dt} \\ \frac{d {Ψ}_{β}}{dt}\end{matrix} ] \qquad ( 4 )$$

Thus,

ψ_{α}=∫e_{α}dt=∫(U_{α}−Ri_{α})dt (5)

ψ_{β}=∫e_{β}dt=∫(U_{β}−Ri_{β})dt (6)

The resistances R in the equations (5) and (6) may be directly measured, such that ψ_{α} and ψ_{β} in the two-phase α-β stationary coordinate system may be directly obtained by integration.

Further, ψ_{α} and ψ_{β} may also be expressed as:

$$[ \begin{matrix}{Ψ}_{α} \\ {Ψ}_{β}\end{matrix} ] = {L}_{u} [ \begin{matrix}{i}_{α} \\ {i}_{β}\end{matrix} ] + L ( θ ) {k}_{s} [ \begin{matrix}cos θ \\ sin θ\end{matrix} ] \qquad ( 7 )$$

where Lᵤ denotes phase winding inductance when the center of a stator salient pole coincides with the center of a rotor notch, and L(θ)kₛ is a variable parameter, and is related to the structure of the motor, the rotor position, the current, the core saturation, etc.

An unknown quantity kₛ is eliminated by the simultaneous equations (5), (6) and (7), and the rotor position may be calculated as:

$$θ = {tan}^{- 1} \frac{{Ψ}_{α} - {L}_{u} {i}_{α}}{{Ψ}_{β} - {L}_{u} {i}_{β}} \qquad ( 8 )$$

where a rotor position angle θ may be obtained, and the speed ω of the rotor position may be obtained by taking a first order derivative of the rotor position angle θ.

$$ω = \frac{d θ}{dt} \qquad ( 9 )$$

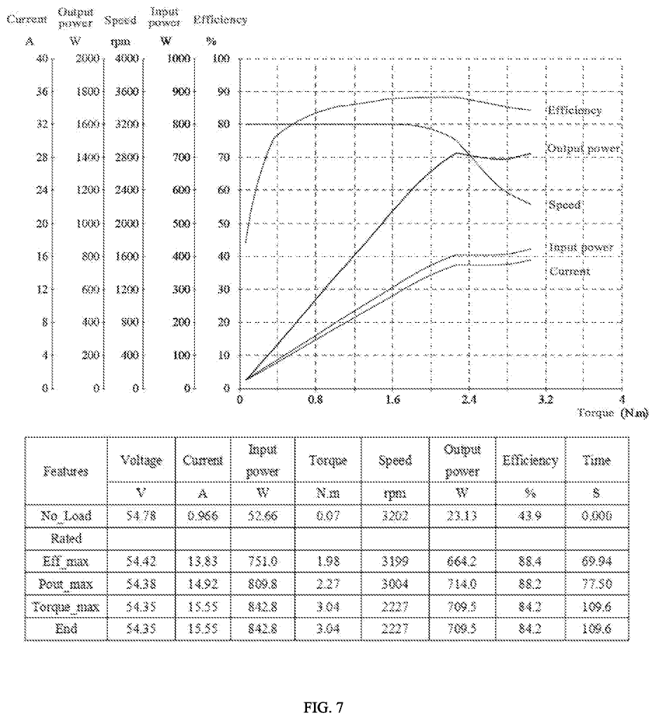

FIG. 7 shows a specific point data table and a power measurement data graph obtained from a physical prototype tested on a dynamometer by adoption of the above-mentioned sensorless rotor position estimation method. The maximum efficiency point is 88.4%, while the maximum efficiency point of a surface-mounted permanent magnet motor with a position sensor in the same application is 85%. Thus, the feasibility and superior performance of the six-phase switched reluctance motor and the sensorless rotor position estimation method according to the present invention are verified.

According to the present invention, the wiring method and the motor structure of the six-phase switched reluctance motor are improved, the voltage and current in the six-phase windings are sampled in real time through the data acquisition module, the flux linkage is calculated through the data processing module, and the rotor position is estimated through the inductance calculation module. Therefore, the advantages of simple structure, easy implementation, high practicality, high calculation accuracy and high reliability are achieved.

The above-mentioned embodiments are merely preferred embodiments of the present invention, and are not intended to limit the scope of the present invention, and any insubstantial changes and substitutions made by a person skilled in the art on the basis of the present invention fall within the scope of the present invention as claimed.

1. A six-phase switched reluctance motor comprising a stator assembly and a rotor assembly, characterized in that the stator assembly comprises a stator core, the stator core comprises stator teeth and a stator yoke, and the stator teeth are provided with windings; and
the number Ns of the stator teeth is a multiple of 6, every six adjacent windings form a six-phase winding, a plurality of sets of six-phase windings are provided, one ends of each set of six-phase windings are connected to each other to form a common terminal, and the other ends of each set of six-phase windings are connected to a controller interface.

2. The six-phase switched reluctance motor according to claim 1, characterized in that a relationship between the number Ns of the stator teeth and the number Nr of rotor teeth meets:
$$\frac{{N}_{s}}{{N}_{r}} = \frac{6}{5} or \frac{6}{7} .$$

3. The six-phase switched reluctance motor according to claim 1, characterized in that a winding manner of the six-phase windings is NNNNNN or SSSSSS or NSNSNS or NNSSNN or NNNSSS, N representing winding in a clockwise direction, S representing winding in a counterclockwise direction.

4. The six-phase switched reluctance motor according to claim 3, characterized in that a winding manner of the six-phase windings is NNNNNN or SSSSSS in the case that the number Ns of the stator teeth is 12.

5. The six-phase switched reluctance motor according to claim 1, characterized in that the stator yoke at least comprises hsy0 and hsy1 areas of unequal widths, and the hsy0 areas and the hsy1 areas are arranged alternately in a circumference direction of the stator yoke.

6. The six-phase switched reluctance motor according to claim 1, characterized in that the six-phase switched reluctance motor is provided as an outer rotor motor or an inner rotor motor or a linear motor or a disc motor or a cascade motor or a special-shaped motor.

7. The six-phase switched reluctance motor according to claim 1, characterized in that auxiliary permanent magnets or/and electrically excited windings are disposed on the stator assembly or/and the rotor assembly.

8. The six-phase switched reluctance motor according to claim 1, characterized in that the stator core is of a salient pole structure; and the rotor assembly comprises a rotor core, the rotor core is also of a salient pole structure, the rotor core comprises rotor teeth and a rotor yoke, and when the rotor assembly is driven by an external force to make directional movement, the rotor teeth cut a magnetic field on the stator windings to form an induced current output, such that the six-phase switched reluctance motor has a function of efficient electricity generation.

9. A sensorless rotor position estimation method for a six-phase switched reluctance motor, implemented by the six-phase switched reluctance motor according to claim 1, characterized by comprising:
acquiring a current value and a voltage value in six-phase windings, a control waveform in the six-phase windings being square wave, sine wave or part of sine wave;
calculating a flux linkage value based on the acquired current value and voltage value; and
estimating an actual position and operating speed of a rotor assembly based on the current value, the voltage value and the flux linkage value.

10. A sensorless rotor position estimation system for a six-phase switched reluctance motor, characterized by comprising:
a data acquisition module, configured to acquire a current value and a voltage value in six-phase windings, a control waveform in the six-phase windings being square wave, sine wave or part of sine wave;
a data processing module, configured to calculate a flux linkage value based on the acquired current value and voltage value; and
an inductance calculation module, configured to estimate an actual position and operating speed of a rotor assembly based on the current value, the voltage value and the flux linkage value.
